(19) United States
(12) Patent Application Publication
(10) Pub. No.: US 2014/0174470 A1
(43) Pub. Date: Jun. 26, 2014

(54) Cleaning Device for Objects in a Body of Water

(71) Applicant: Anne-Marthe Dalseide, Bakkasund (NO)

(72) Inventor: Anne-Marthe Dalseide, Bakkasund (NO)

(21) Appl. No.: 14/116,108

(22) PCT Filed: Apr. 25, 2012
(86) PCT No.: PCT/NO2012/050077

§ 371 Date: Dec. 27, 2013

(30) Foreign Application Priority Data
May 10, 2011 (NO) 20110686

(51) Int. Cl. B08B 3/04

(52) U.S. Cl. CPC B08B 3/04
USPC 134/6; 134/184

(57) ABSTRACT

A device is for cleaning objects in a body of water. The device includes: a plurality of cleaning elements; a plurality of supporting elements; and a collar, to which first ends of the supporting elements are attached. The cleaning elements are attached to the supporting elements. One or more of the supporting elements slope with its/their second, free end(s) in towards at least one point outside the collar, so that the supporting elements and the collar form at least one funnel. A method is for cleaning objects in a body of water using a cleaning device.

The invention relates to a device for cleaning objects in a body of water. More specifically, the device relates to a cleaning device for an object moving in the body of water, the movement of the object creating a relative motion between the cleaning device, which is enclosing contact with the object, and the object because of the geometric design of the cleaning device which gives increased towing resistance. Thus, an object is cleaned by the friction arising between the cleaning device and the object by the relative motion. The invention also relates to a method of cleaning objects in a body of water by means of said cleaning device.

In what follows, the object in the body of water will be exemplified by a hydrophone cable, a so-called seismic streamer, which is used in seismic acquisition, even though the invention, as described in what follows, is not restricted to streamers but also includes, but is not limited to, ropes, chains and mooring devices.

Seismics is a geophysical method of mapping geological structures. The method is used in an early phase in the exploration of petroleum deposits, among other things. In marine Seismics, one or more long cables, streamers, are towed behind a ship together with air guns, so-called “gun arrays”. The air guns emit pressure waves which are partially reflected from geological boundaries below the sea floor. The reflected signal is recorded by a plurality of seismic sensors, generally hydrophones, located inside the streamers. Such streamers may be several kilometres long and they are usually towed at a few metres' depth. It is very important to have control of the depth and direction of the streamers in the mass of water to optimize the quality and reproducibility of the seismic data acquired. The streamers are therefore provided with a plurality of depth controllers, so-called “(compass) birds”. Overtime, various forms of maritime fouling will attach to the streamers, that being sea grass, barnacles and the like. Maritime fouling and other types of contaminants on the streamers may deteriorate the quality of the seismic acquisitions in that said contaminants and fouling will affect the transmission of seismic energy to the sensors. In addition, said impurities may create noise in the measurements, damage the streamer and increase the towing resistance/drag from the streamer in the body of water. Removing such impurities from a streamer is therefore important.

Several different methods of cleaning seismic streamers are known. Cleaning is often done manually by means of provisional brushing and scraping tools. This may be done from a work boat running along the cable, for example.

Patent document U.S. Pat. No. 7,145,833 discloses a cylinder-shaped device for automatically cleaning seismic cables. A cylinder-shaped tight shell is provided with at least one vane thereon, the vane being arranged to create longitudinal and rotational motion of the device around a streamer moving in a body of water. The inside of the cylinder-shaped shell is further provided with at least one cleaning element which is brought into contact with the external surface of a streamer and which follows the movement of the cylinder shell.

Patent document US 2006/005186 discloses a device for the automatic cleaning of seismic cables as well, said device being attached around the cable so that the drag provided by the device as it is being moved in a body of water moves the cleaning device along the length of the seismic cable.

Further, patent document U.S. Pat. No. 4,542,555 discloses a device for cleaning ropes of oil residues and the like. A plurality of elongated tongues are attached to a frame surrounding the ropes, the tongues being arranged to press, under hydraulic pressure, against the rope with their free ends while, at the same time, the rope is being pulled through the device.

Known solutions, some of which have been mentioned hereinbefore, have one or more of the drawbacks which will be mentioned in what follows.

Some known methods of cleaning seismic cables are based on the cables being removed from the body of water. As a rule, this will be carried out by reeling the cable onto a drum in order then to transport it to a given location for cleaning and defouling in a manner known per se, often including the use of environmentally unfriendly chemicals. This may put the streamer out of operation for a longer period. Alternatively, a streamer may be cleaned from a boat moving along the streamer. For example, the work may be carried out with a scraper, a brush or a rope or combinations thereof. Cleaning streamers from a boat may be both difficult and dangerous. Further, “self-propelling” devices for the cleaning of streamers, some of which have been described in the above-mentioned patent documents, will often be unable to pass and/or clean birds. The devices are often heavy and unwieldy because of their construction and material properties. Further, devices based on the rotation of non-surrounding cleaning elements that are moving along the cable at the same time may give an imperfect cleaning of the cable as parts of the outer periphery of the cable will not be cleaned. Some of the known cleaning devices use transmission of the motion of the device in the body of water into a “cleaning” motion via one or more motion transformations, at least one of which is from translatory into rotational motion or vice versa, which entails an efficiency loss.

The invention has for its object to remedy or reduce at least one of the drawbacks of the prior art or at least provide a useful alternative to the prior art.

The object Is achieved through features which are specified in the description below and in the claims that follow.

In a first aspect, the invention relates to a device for cleaning objects in a body of water, the cleaning device including:
a plurality of cleaning elements;
a plurality of supporting elements; and
a collar, to which first ends of the supporting elements are attached, characterized by the cleaning elements being attached to the supporting elements; and by one or more of the supporting elements sloping with its/their second, free end(s) in towards at least one point outside the collar, so that the supporting elements and the collar form at least one funnel.

In one embodiment, the at least one funnel may be formed as a cone. This will have the effect, among others, of enabling objects of different sizes to be cleaned better and to pass through one and the same cleaning device with little risk of sticking.

The cleaning elements may be, for example, but are not limited to, a brushing or scraping device or a combination thereof. Preferably, the cleaning elements may be replaceably attached to the supporting elements in a manner known per se. In an alternative embodiment, the cleaning elements may also be an integrated part of the supporting elements.

In one embodiment, the at least one funnel of the cleaning device may be pointed; that is to say, the free ends of the supporting elements extend substantially all the way in to the at least one point outside the collar. In an alternative embodiment the funnel may also be truncated in the case in which the free ends of the supporting elements do not extend all the way in to said at least one point. The device may be provided in different sizes, but in one non-limiting embodiment, the diameter of the collar may be in the order of 1 metre,, whereas the height of the device (height of the largest funnel) may be just over 1 metre.

In a preferred embodiment, the collar may be dividable. This will be an advantage if the cleaning device is to be placed around an elongated body like, for example, but not limited to, a seismic streamer. Even if a front end of the streamer is attached to a bellows or the like, the cleaning device may he slipped over the streamer by the fact that the collar may he divided and put back into place. The collar can be held together and released by a hinge, a quick-release coupling or a resilient coupling, for example. Said couplings, individually or in combination, may have the effect of enabling the cleaning device to be yanked off a streamer or the like with a rope or some form of gripping device, for example. The collar may be provided with one or more dividing points, one or more of which may be provided with a hinge or coupling as mentioned above.

It will be an advantage if the supporting elements and the cleaning elements together form a flexible unit. This has the effect of enabling the device to clean objects of different sizes. In one embodiment, the supporting elements and/or the cleaning elements may be provided in an elastic material and, thus, be dynamically adjusted to surround differently sized objects. The elastic material may be, for example, but is not limited to, a plastic- or rubber-based material. In an alternative embodiment, the supporting elements may also be resiliency attached to the collar so that, from the spring joint, the supporting elements may be moved radially in and out from the normal axis of the funnel. The supporting elements may, with advantage, but do not have to, be individually flexible.

In a preferred embodiment of the cleaning device, the at least one point outside the collar, in towards which the supporting elements are sloping, may be on an axis substantially normal to the base of the funnel, extending through the centre of the base. Thus, the cleaning device will be provided as at least one straight funnel, which may be a cone, for example. This will have the effect of making it easier for an object of a circular or cylindrical shape to pass through the cleaning device and enabling the object to be cleaned evenly around its circumference.

In a further preferred embodiment, the collar of the device may have a width substantially normal to the height of the funnel. This will have the effect of the drag/towing resistance on the device in a body of water increasing, so that it will be possible to achieve relative motion between a cleaning device, placed around an object in motion in a body of water, and the object. In the case of cleaning seismic streamers, the towing resistance on the cleaning device will lead to the cleaning device moving against the travailing direction relative to the streamer, and the surface of the streamer being cleaned because of the friction between the cleaning elements and the streamer.

The collar may be circular, for example, but other geometric shapes may be appropriate in some embodiments.

It may be an advantage if the cleaning device includes at least two funnels. This means that objects that are to be cleaned will have to pass through at least two sets of cleaning elements, thereby being cleaned better. The various funnels will have different heights but like bases, so that objects passing or being pulled through the cleaning device will be cleaned by at least two successive sets of cleaning elements.

In one embodiment, each funnel may be formed of one set of supporting elements, each set consisting of two diametrically opposite pairs of supporting elements attached to the collar. Each set thereby consists of two pairs of supporting elements, preferably placed on either side of the at least one dividing point of the dividable collar. This has the advantage of enabling the supporting elements with associated cleaning elements to be parted as well, when the collar is divided, so that, for example, a streamer can be placed in the cleaning device for cleaning.

In a preferred embodiment, the at least two sets of supporting elements may be angularly spaced relative to each other around the collar of the device. This will have the effect of enabling the surface of an object passing through the cleaning device to be cleaned in several places simultaneously, without the need of providing relative rotational motion between the object and the cleaning device. For example, the entire outer circumference of a streamer may be cleaned in that the at least two sets of supporting elements with associated cleaning elements are angularly spaced relative to each other.

In a second aspect, the invention relates to a method of cleaning objects in a body of water, the method utilizing a device including:
a plurality of cleaning elements;
a plurality of supporting elements; and
a collar, to which first ends of the supporting elements are attached, characterized by the cleaning elements being attached to the supporting elements; and by one or more of the supporting elements sloping with its/their second, free end(s) in towards at least one point outside the collar, so that the supporting elements and the collar form at least one funnel; characterized by the method including:
positioning the cleaning device around the object to be cleaned; and
providing relative motion between the cleaning device and said object.

In what follows, a non-limiting example of a preferred embodiment is described, which is visualized in the accompanying drawings, in which;

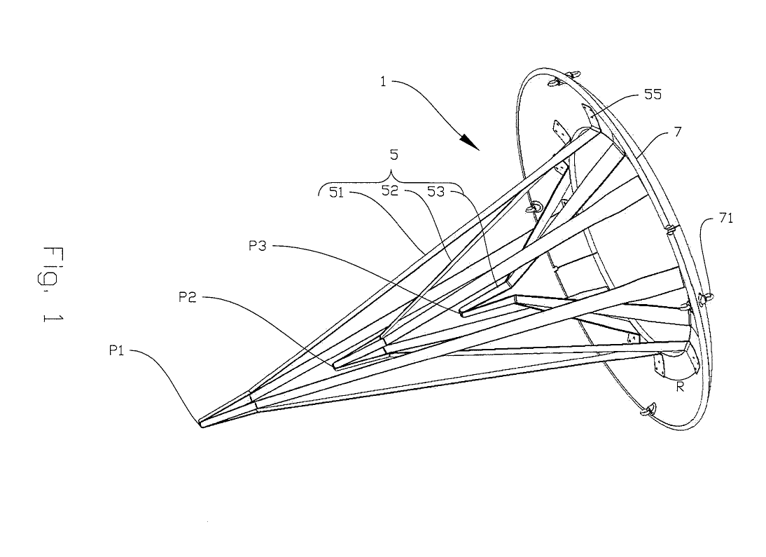

FIG. 1 shows a closed cleaning device without cleaning elements, in perspective;

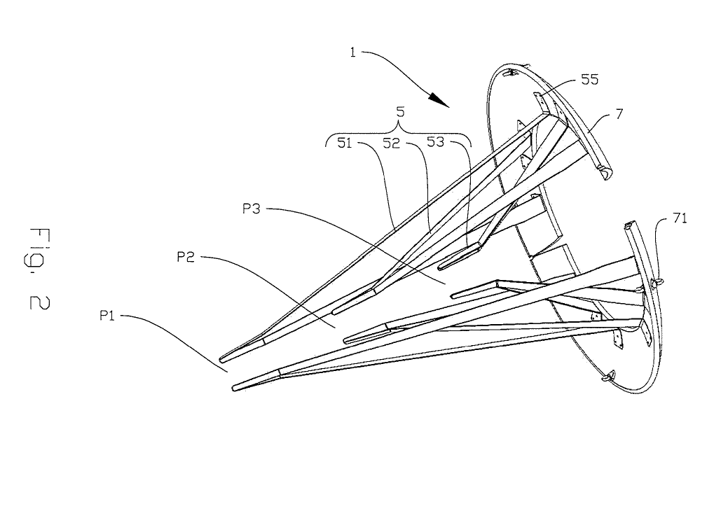

FIG. 2 shows an open cleaning device without cleaning elements, in perspective;

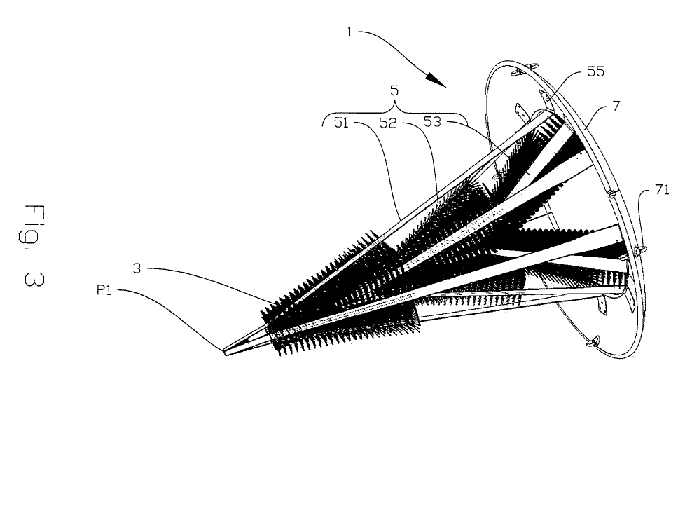

FIG. 3 shows a closed cleaning device with cleaning elements, in perspective;

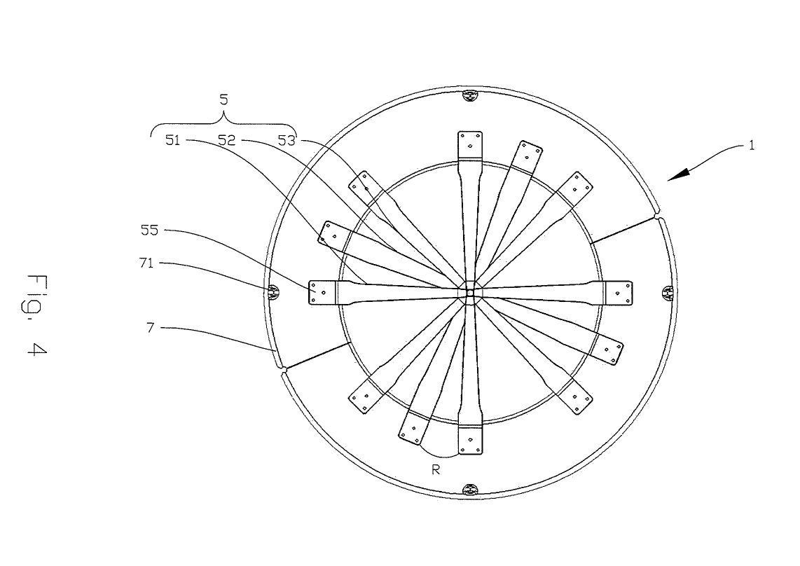

FIG. 4 shows a closed cleaning device without cleaning elements, viewed from above; and

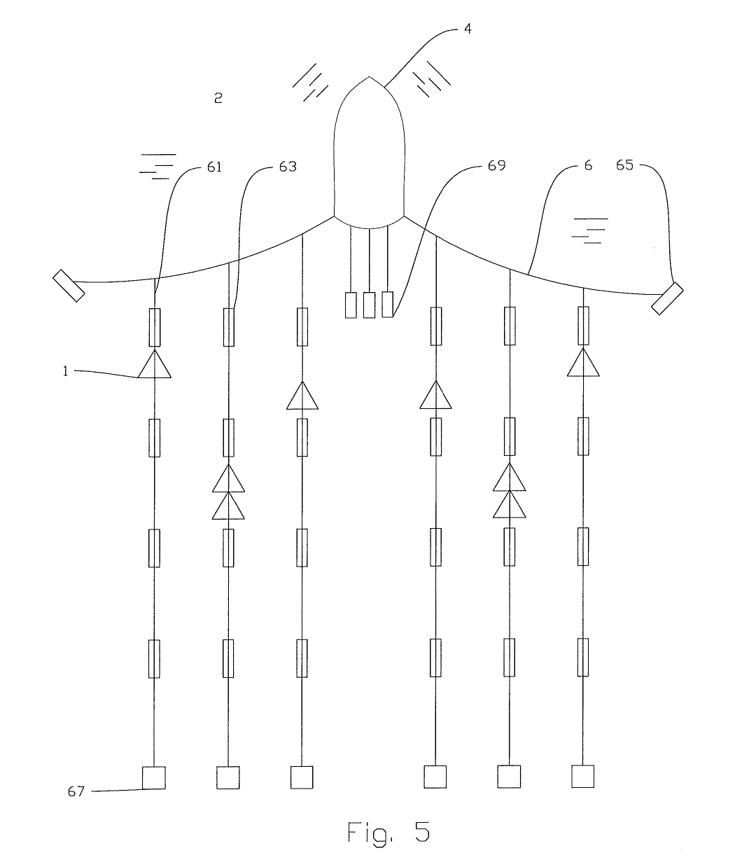

FIG. 5 shows, on a smaller scale, several cleaning devices used together with a seismic vessel during the acquisition of seismic data, viewed from above.

In what follows, the reference numeral 1 indicates a device in accordance with the invention. In the FIGS. 1, 2 and 4, the device 1 is shown without cleaning elements 3 for reasons of exposition, but in its position of application, the device 1 will be provided with a plurality of cleaning elements 3 attached to the supporting elements 5 as it is shown in FIG. 3. In the figure, the cleaning elements 3 are shown as a plurality of brushes. Each of the supporting elements 5 is attached by a first end to a collar 7. In the figures, the supporting elements 5 are shown with a supporting base 55 for better attachment to the collar 7. In the exemplary embodiment shown, the supporting elements 5 are further arranged in three sets 51, 52, 53, each set 51, 52, 53 consisting of two pairs of supporting elements 5, the two pairs having diametrically opposite attachments to collar 7. The three sets 51, 52, 53 of supporting elements 5 slope with their second, free ends in towards the points P1, P2 and P3, respectively., so that the cleaning device 1 is formed as three funnels placed one outside the other, shown in the figures in the shape of cones.

The collar 7 is arranged to be dividable, as it is shown in FIG. 2. Thus, it is an advantage if the pairs of supporting elements 5 of diametrically opposite attachments are placed on either side of the dividing point of the collar 7, as it is shown in the figures. In that way, the cleaning device 1 may more easily be placed around an object. In particular, the dividable collar 7 will be appropriate when the cleaning device 1 is being attached to elongated objects such as streamers 61, chains or ropes, for example.

The collar 7 has a width normal to the height of the cone shape. This will have the effect of the device 1 having great towing resistance in a body of water 2, so that its speed in the body of water 2 will be lower than the speed of a streamer 61 which is being towed in the body of water 2 and around which the device 1 is positioned. Relative motion is thereby provided by a cleaning device 1 in enclosing contact with a streamer 61.

The portion of the device 1 between the supporting elements 5 is open so that water may flow through the device 1, and the towing resistance on the device 1 is primarily constituted by the collar 7 of the device 1.

The three sets 51, 52, 53 of supporting elements 5, each forming a cone shape, are angularly spaced by an angle R relative to each other for reasons mentioned in the above.

Each of the supporting elements 5 is further shown as being provided with a dog-leg near its free end, so that the angle of slope of the supporting elements 5 decreases somewhat in a portion near the points P1, P2 and P3, respectively. The latter, less sloping portion is shown without brushes 3 and may then function as a scraper after the various brush assemblies while, at the same time, It may counteract the sticking of objects in the cleaning device 1.

The collar 7 is shown as being provided with a plurality of eye bolts 71 extending through the collar 7 and having an eye on either side. This may be appropriate if several devices 1 are to be run interconnected. The devices 1 may then be attached to each other with ropes, strings or the like.

The collar 7 and supporting elements 5 of the device 1 may be made out of, for example, but are not limited to, plastic, rubber, fibreglass or coated steel. The cleaning elements 3 of the device 1 may be formed out of a rubber- or plastic-based material, for example.

In FIG. 5, a sketch of a seismic vessel 4 towing several streamers 61 is shown. The streamers 61 are attached at their front ends to a bellows 6 which is kept extended by two otter boards 65. Attached to the vessel 4, there are also several pressure sources (air guns) 69, arranged to emit pressure waves that are reflected from geological transitions in the bedrock and then registered by a plurality of sensors, such as hydrophones, not shown, placed inside the streamers 61. At their rear, free ends, the streamers 61 are shown as being provided with a tail buoy 67. The tail buoy 67 will typically include a buoyancy body, radar reflector and light. Along the streamers 61, several cleaning devices 1 according to the invention are positioned. The cleaning devices 1 may occur one by one or interconnected as shown in the figure. A plurality of birds 63 are attached to the streamers for purposes mentioned initially. The cleaning device 1 according to the invention will be moved relative to a streamer 61 from the front end of the streamer at the bellows 6 rearwards, towards the tail buoy 67, as the seismic vessel 4 is moving. The surface of the streamers 61 is cleaned because of the friction between the cleaning elements 3 and the streamer 61 and the relative motion between them, arising because of the geometric construction of the device 1, The device 1 according to the invention will also be able to pass birds 63, provided the collar 7 has a diameter which is large enough to let the birds 63 through, by the supporting elements 5 and/or cleaning elements 3 being moved radially outwards, elastically, when meeting a bird 63. The supporting elements 5 and/or cleaning elements 3 then contract into the starting position around the streamer 61.

1. A device for cleaning objects in a body of water, the device comprising:
a plurality of cleaning elements;
a plurality of supporting elements; and
a collar, to which first ends of the supporting elements are attached, wherein the cleaning elements are attached to the supporting elements and one or more of the supporting elements are sloping with its/their second, free ends in towards at least one point outside the collar, so that the supporting elements and the collar form at least one funnel, so that, when placed in enclosing contact with the object in the body of water, and when relative motion has been brought about between the device and the object, the device is arranged to clean the object.

2. The device in accordance with claim 1, wherein the at least one funnel is formed as a cone.

3. The device in accordance with claim 1, wherein the collar is dividable.

4. The device in accordance with claim 1, wherein the supporting elements together with, the cleaning elements form a flexible unit.

5. The device in accordance with claim 1, wherein the at least one point outside the collar, in towards which the supporting elements are sloping, is on an axis substantially normal to the base of the funnel, extending through the centre of the base.

6. The device in accordance with claim 1, wherein the collar has an extent in a plane substantially normal to the height of the funnel.

7. The device in accordance with claim 1, wherein the collar and the plurality of supporting elements form at least two funnels.

8. The device in accordance with claim 1, wherein each funnel is formed of one set of supporting elements each set being formed of two pairs of supporting elements.

9. The device in accordance with claim 7, wherein the at least two sets of supporting elements are angularly spaced by an angle relative to each other around the collar of the device.

10. A method of cleaning objects in a body of water, the method utilizing a device comprising:
a plurality of cleaning elements;
a plurality of supporting elements; and
a collar, to which first ends of the supporting elements are attached; where the cleaning elements are attached to the supporting elements; and where one or more of the supporting elements are sloping with its/their second, free end(s) in towards at least one point outside the collar, so that the supporting elements and the collar form at least one funnel wherein the method comprises:
bringing the cleaning device into enclosing contact with the object which is to be cleaned;
bringing about relative motion between the cleaning device and said object.
